(19) United States
(12) Patent Application Publication
(10) Pub. No.: US 2008/0069089 A1
(43) Pub. Date: Mar. 20, 2008

(54) Method for Transmitting Signalling Information Via a Network Limiting Element in a Communications Network

(76) Inventors: Jurgen Raisch, Munchen (DE); Robert Schmelter, Munchen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/632,135

(22) PCT Filed: Jun. 7, 2005
(86) PCT No.: PCT/EP05/52594

§ 371 Date: Jan. 10, 2007

(30) Foreign Application Priority Data
Jul. 12, 2004 (DE) 102004033648.2

(51) Int. Cl. H04L 12/66

(52) U.S. Cl. 370/355

(57) ABSTRACT

A method for transmitting signaling information via a network limiting element, which interconnects a packet-switched communications network and a circuit-switched communications network is provided. The network limiting element having interfaces that are respectively connected to the packet-switched communications network by a message-oriented control channel and a connection-oriented control channel. At least one of the interfaces comprises an active connection unit and a redundant connection unit. The method is characterized in that during a changeover from the active connection unit to the redundant connection unit, a state transmission is carried out between the message-oriented control channel and the connection-oriented control channel in such a way that the connection-oriented signaling is controlled by the message-oriented signaling.

### CROSS REFERENCE TO RELATED APPLICATIONS

This application is the US National Stage of International Application No. PCT/EP/2005/052594, filed Jun. 7, 2005 and claims the benefit thereof. The International Application claims the benefits of German application No. 102004033648.2 DE filed Jul. 12, 2004, both of the applications are incorporated by reference herein in their entirety.

### FIELD OF INVENTION

The invention relates to a method for transmitting signalling information via a network limiting element, which connects a packet-switched communications network and a circuit-switched communications network.

### BACKGROUND OF INVENTION

In conventional telecommunications networks speech information has previously predominantly been transferred according to a switching principle in which a continuous channel is switched for the entire duration of the connection. All data transmitted during the connection takes the same path and always arrives at the receiver in the sequence in which it was brought onto the path.

In packet-oriented data networks, such as the internet, the data is sent through the network broken down into portions, rather than physical channels being permanently through-switched for the duration of a connection.

Communication connections via the internet, in which real-time data, such as speech or video information, is transmitted, largely function according to the same pattern. The real-time information is digitised, compressed and forwarded to its destination in the form of data packets via active network connection nodes—the routers—according to specific rules. To establish a connection the selected call number must be converted in advance into an IP address. The IP address appears as destination information in the message header of the data packet. The connection-oriented character of the message transfer is only discernible in higher network layers, for example of the TCP (Transmission Control Protocol) or SCTP (Stream Control Transmission Protocol) because viewed at the lowermost IP level there is no connection between the connection points. The individual data packets are directed by the sender into the network without them being made aware of whether, when and how these data packets have reached the receiver. In the terminal equipment the speech information is removed from the data packets and made audible again by codec (compression/decompression).

With a Voice over IP connection (VoIP), network limiting elements, for example gateways, form a transmission interface for the connection between IP world and public operator network (PSTN). The central function of these network limiting elements is the conversion of the different data formats used in an inter-network connection during transport, sequential control and audio/video processing. In the inter-network connection the gateways provide for the establishment and dismantling of connections and take on packing into data packets as well as the compression process. The signalling information, which is necessary to establish and dismantle connections, is transmitted via these network limiting elements in addition to the payload. As a result of signalling information a conference call for example may be established or a third call may be displayed during a call (call waiting) or further features may be provided for use by the communication users.

As in conventional telecommunications networks “Voice or Communication over IP” connections are guided by network elements in which central functional units are duplicated for safety reasons. In the event of a fault a changeover can therefore be made to the functional unit that is held in readiness.

With Voice over DSL (Digital Subscriber Line) what are known as access gateways (AGW) are used as remote gateways to connect from 1,000 to 50,000 analogue and ISDN telephones. An access gateway comprises interfaces that are situated toward the data network and have redundant connection units. An access gateway is controlled via control channels, which are connected to the connecting units of the interfaces, by a Packet Control Unit (PCU) of the packet-switching network. On the circuit-switched side of the communications network an access gateway completes the ISDN protocol.

With a changeover to a redundant connection unit, whether this changeover is triggered in the event of a fault of by manual reconfiguration, the problem of protocol-internal signalling data, such as the “Transmission Control Block” not being known occurs and the connection has to be re-established. The consequence of this is that all signalling messages are automatically lost until the corresponding connection is re-established. The signalling protocols currently used at the interface to the packet-switched network have the drawback that they take a long time to recognise the non-existence of this connection, however. The situation may occur therefore that signalling is interrupted for up to a minute and as a consequence it is only then that a connected ISDN user for example can set up or disconnect a call.

### SUMMARY OF INVENTION

An object underlying the present invention is to disclose a method for transmitting signalling information via a network limiting element in such a way that the loss of signalling information on a changeover to a redundant connection is as low as possible.

This object is achieved by the features of the independent claim. The dependent claims make reference to advantageous embodiments of the invention.

According to the invention it is provided that in the connection to the data network a state transmission is carried out between a message-oriented channel and a connection-oriented control channel, so the connection-oriented control channel is controlled by the message-oriented channel. Consequently the time for re-establishing a connection following a changeover is considerably reduced. The interruption to service between connected ISDN communication users can consequently usually be reduced to less than 1 s and is scarcely noticed by the communication users.

By contrast a changeover from an operating access gateway interface (AGW-IF) to a redundant access gateway interface in systems according to the prior art lasts up to two minutes. The service interruption that accompanies this changeover (IP failover) is regarded by connected ISDN communication users as being very disruptive. Furthermore financial disadvantages accrue for the network operator: if for example the failure of the SCTP/IUA connection in the case of an IP failover of an AGW-IF with up to 10,000 users lasts 1 min according to conventional technology, the operator may lose
2 calls/sec (per 1,000 users)*10*60 sec=1,200 calls
as a result which it cannot switch and therefore cannot charge for (1,000 users/connection group). Should every fifth AGW-IF of a large AGW with up to 50,000 users accordingly carry out an IP failover, the number of lost calls may increase fivefold:
2 calls/sec (per 1,000 users)*50*60 sec=6,000 calls.

With the invention however failure of the SCTP/IUA connection is limited to 1 sec and this ensures that no calls are lost since all signalling timers are greater than one second.

The state transmission according to the invention is advantageously triggered at the same time as initiation of the changeover in the access gateway (AGW).

In a preferred embodiment of the invention it is provided that the changeover in the access gateway triggers generation of what is referred to as the “Service Change: Failover” message which is transmitted from the access gateway to the Packet Control Unit (abbreviated: PCU). The interruption to the SCTP/IUA connections may be reduced to less than a second by the termination being signalled immediately and the previously conventional recognition time ceasing to apply.

It is advantageous if the MGCP protocol is used in the message-oriented control channel and the SCTP protocol in the connection-oriented control channel to transmit signalling information.

A particularly preferred embodiment of the method is characterised in that the packet control unit has a maintenance functional unit (Mnt) and an adaptation functional unit (IUA). The signalling message is transmitted to the maintenance functional unit by message-oriented signalling. After receiving the signalling message receipt is announced in the maintenance functional unit to the adaptation functional unit, so the adaptation functional unit can establish a signalling connection to the redundant connection unit via connection-oriented signalling.

### BRIEF DESCRIPTION OF THE DRAWINGS

The invention will be described by way of example hereinafter with reference to the accompanying drawings, in which:

FIG. 1 shows a topology of a heterogeneous communications network in which at the interfaces between a circuit-switched sub-net and a packet-switched sub-net there are arranged respective network-limiting elements to convert the different data formats in the sub-nets,

FIG. 2 shows an interface configuration between an access gateway and a packet control unit before changeover to a redundant connection unit,

FIG. 3 shows an interface configuration between an access gateway and a packet control unit after changeover to a redundant connection unit,

FIG. 4 shows a VoDSL connection between two communication users A and B, with the access gateway being connected to a packet control unit by control channels and IP network.

### DETAILED DESCRIPTION OF INVENTION

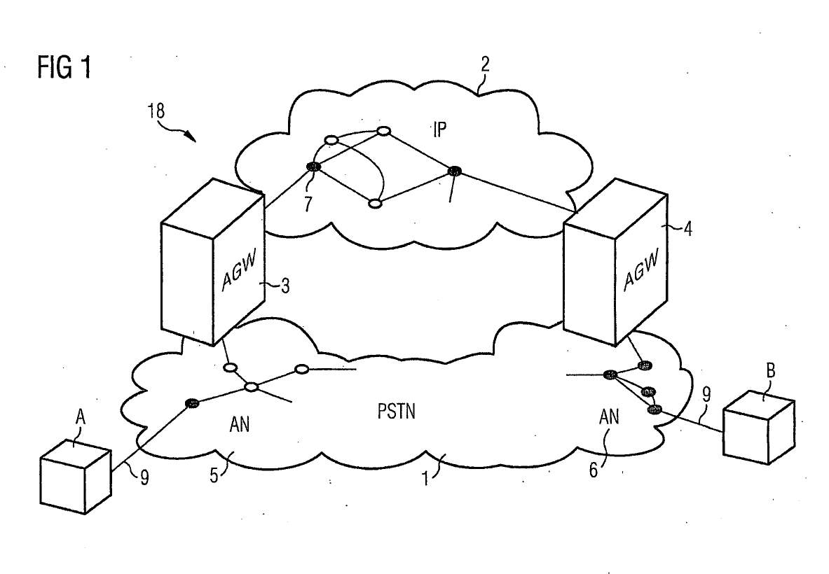

FIG. 1 shows a heterogeneous communications network 18 which comprises two sub-nets, a circuit-switched communications network 1, the telecommunications network PSTN in the example, and a packet-switched communications network 2, the internet IP in the example. The terminal equipment of the communication users A and B are each connected to the access networks 5 and 6 of the circuit-switched communications network 1 by connection lines 9. The connection of the end device may be an ISDN connection or an analogous connection. Network limiting elements 3, 4 are depicted at the interfaces between the sub-nets 1 and 2 in each case. In the present example of a voice over IP connection these network limiting elements 3 and 4 are constructed as an access gateway between the subscribers A and B. The main task of this access gateway is to carry out the conversion of the different data formats used in the inter-network connection of the sub-nets 1 and 2 for transport, to carry out sequential control, and processing of audio data. The access gateways 3 and 4 also provide for the establishment and dismantling of connections in the inter-network connection and take on packing of the data packets as well as the compression process. In the ISDN network payloads and signalling information are transmitted on separate transmission channels. Transmission of signalling information and payloads on separate transmission paths also takes place in an access gateway. Protocols H.323 and the Session Initiation Protocol (SIP) are common as end-to-end signalling methods. The access gateways 3 and 4 are controlled by what are known as gateway or routing protocols MGCP (Media Gateway Control Protocol) or H.248/Megaco. The gateways 3 and 4 are controlled by a central instance, the packet control unit 7 (PCU), on the part of the packet-switched network 2.

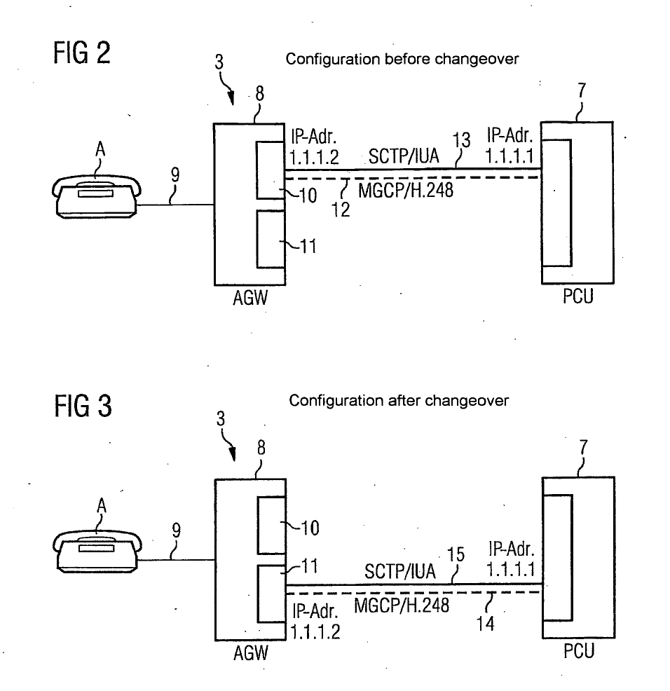

FIGS. 2 and 3 each show a simplified view of an interface configuration between an access gateway (AGW) 3 and a packet control unit (PCU) 7. The end device of communication user A is connected to the access gateway 3 by a user connection line 9. The interface 8 of the access gateway AGW 3 comprises two connection units 10 and 11. In FIG. 2 the connection unit 10 is connected to the packet control unit PCU 7 by a message-oriented control channel 12 and by a connection-oriented control channel 13. The protocol MGCP/H.248 is used in the message-oriented control channel 12. The Stream Control Transmission Protocol SCTP/IUA is used in the connection-oriented control channel 13. These signalling protocols use the IP addresses 1.1.1.2 and 1.1.1.1. FIG. 2 shows the configuration before the changeover, i.e. the connection unit 11 of the access gateway interface 8 is provided for a changeover in the event of a fault.

FIG. 3 shows the configuration after the changeover to the redundant connection unit 11. The connection unit 11 is connected to the packet control unit 7 by the message-oriented control channel 14 and by the connection-oriented control channel 15. Since the IP address also moves to the physically redundant unit following a changeover, the redundant connection unit cannot allocate messages of the signalling channel 15 received by the connection-oriented protocol SCTP/UA because there is still no connection. The result of this is that the received signalling data is rejected until a connection is re-established to the Access gateway 3 by the control unit 7 (PCU). The re-establishment of this connection can only take place however once breaking-off of the connection-oriented protocol has been determined. This determination can in turn only take place if, after a fixed number of repetitions, acknowledgement of receipt of a message fails to materialise. By way of addition it should also be noted at this point that establishment of a connection by the access gateway is not possible since for security reasons the access gateway must be operated as a server. Misuse by a hacker is largely ruled out due to the fact that a connection may only ever be initiated by the packet control unit (PCU).

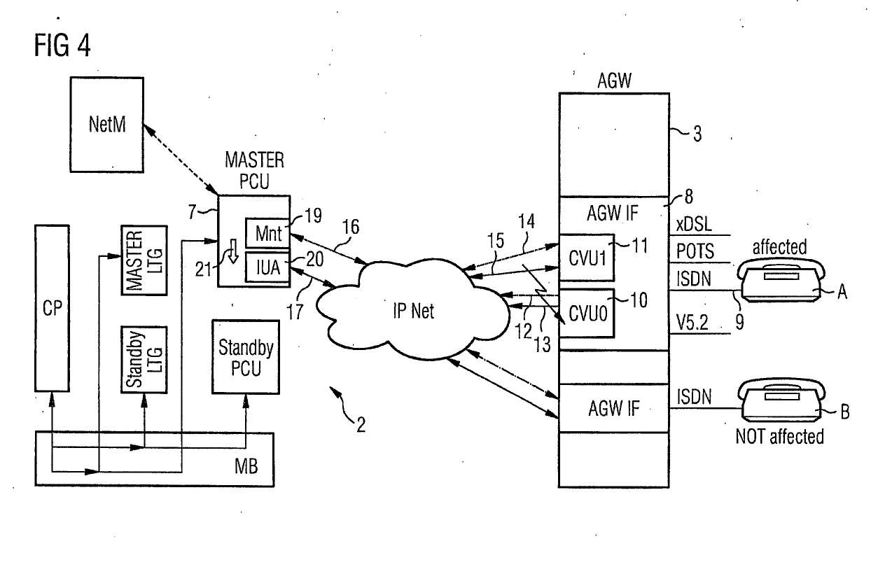

FIG. 4 shows a block diagram of a VoDSL connection between the two communication users A and B, with the access gateway 3 being connected to a packet control unit 7 via the IP network. Access gateways are used to connect a very large number of analogue and ISDN users. The simplified diagram of FIG. 4 shows only two communication users A and B. Communication user A is connected via ISDN to the access gateway 3 by an ISDN connection line 9 with an access network (not shown). Integration of the access gateway 3 into the communications network is indicated by the standard interface V 5.2. On the data network 2 side the access gateway interface (AGW-IF) 8 associated with user connection A has an operating connection unit 10, central voice processing unit 0 (CVU0) and a redundant connection unit 11 that is held in readiness, Central Voice Processing Unit 1 (CVU1). The figure also shows further redundant functional blocks, the standby PCU associated with a master PCU and the standby LTG associated with a master line trunk group (LTG). FIG. 4 also illustrates by way of the designation NetM a higher-order functional unit of a network management. The block designated CP shows the coordination processor; MB designates a message buffer of the network node. Signalling for the message channel of subscriber A initially takes place via the control channels 12 and 13.

Bidirectional signalling information is transmitted between the access gateway 3 and the control unit 7 for this purpose. Protocol MGCP is used on the message-oriented control channel 12 and SCTP on the connection-oriented control channel 12 as the signalling protocols.

If, as illustrated in the introduction, there is accordingly a changeover in the access gateway interface 8 to the redundant connection unit 11, according to the prior art it would take up to a minute, depending on the message traffic on the SCTP connection, for the connection-oriented protocol SCTP on the PCU 7 to determine failure of the previous SCTP/IUA connection (association) by means of an “align” message repeated several times. Only then could the protocol SCTP re-establish an association which would then be terminated at the active central voice processing unit (CVU0 in FIG. 4). During this downtime of about one minute of the connection-oriented SCTP signalling connection (association) no calls may be established or disconnected by an ISDN user connected to this access gateway interface since the call set-up and call disconnection requires SCTP/IUA signalling. The same applies to what are known as feature requests which are also deactivated during this interruption to signalling. According to the invention this problem is solved in that the message-oriented (MGCP-MEGACO) signalling protocol is used to control the connection-oriented signalling protocol SCTP/IUP. Specifically this means that on recognising the changeover to the redundant unit 11 the access gateway 3 generates a signalling message “service change: failover” and introduces this into the IP network 2. The IP network 2 forwards this “service change: failover” message to a maintenance functional unit (Mtn) 19 of the packet control unit (PCU) 7 via a message-oriented signalling protocol 16. After receiving this signalling message “service change-failover” the “maintenance functional unit” 19 accordingly knows that it is no longer CVU 0, the original connection unit 10, that is active but CVU 1, the connection unit 11 held in readiness. This information on the changeover that has taken place from the connection unit 10 to the redundant connection unit 11 is forwarded by the “maintenance functional unit” 19 to the “adaptations unit” (IUA) 20 (arrow 21 in FIG. 4). The adaptation unit 20 accordingly establishes a signalling connection to CVU 1. This signalling connection runs via a connection-oriented control channel 17, via the IP network 2 and via a further connection-oriented control channel 15 to the operating connection unit CVU 1. As soon as this signalling connection exists a call can be established or disconnected again between the communication users A and B or other service features or feature requests may be accessed. Compared with the prior art in which there is a compulsory wait until failure of the connection is recognised and it is only then that the corresponding connection is re-established, re-establishment of the connection-oriented IP connection is significantly accelerated by the invention.

As illustrated in the introduction, in the case of Voice over DSL (VoSDL) an access gateway (AGW) supplies up to 50,000 analogue/digital user connections. All access gateways, which are controlled by a packet control unit (PCU) are set up by way of their IP addresses as VoDSL partners. All service change messages of these IP addresses are therefore passed to VoDSL maintenance (a function in the network which checks the availability of users and in the event of non-availability optionally transmits messages to a higher-order monitoring element). The service change message: “failover” from an AGW accordingly indicates the IP failover thereof. VoDSL maintenance forwards this “service change: failover” message to the layer management of IUA by means of a process-internal communication. This then brings about immediate re-establishment of the relevant SCTP/IUA connection (association), although this is now terminated at the redundant CVU.

1.-5. (canceled)

6. A method for transmitting signalling information via a network limiting element, which connects a packet-switched communications network and a circuit-switched communications network, comprising:
providing the network limiting element having a plurality of gateway interfaces for connecting to the packet-switched communications network via a message-oriented control channel and a connection-oriented control channel, wherein at least one of the plurality of interfaces includes an active connection unit and a redundant connection unit; and
sending over the message-oriented control channel to the packet switched network a state transmission during a changeover from the active connection unit to the redundant connection unit such that a connection-oriented signalling is controlled by a message-oriented signaling,
wherein the redundant connection unit becomes the active connection unit in response to the changeover.

7. The method according to claim 6,
wherein the connection-oriented signalling is based on a SCTP/IUA protocol, and
wherein the message-oriented signalling is based on a MGCP or H.248 protocol.

8. The method according to claim 6, wherein the state transmission is triggered at a same time as the changeover.

9. The method according to claim 8, further comprising:
generating a signalling message by the network limiting element; and
transmitting the generated signaling message to a packet control unit in the packet-switched network.

10. The method according to claim 9,
wherein the packet control unit comprises:
a maintenance functional unit, and
an adaptation functional unit,
wherein the signalling message is transmitted to the maintenance functional unit by the message-oriented signalling,
wherein the maintenance functional unit announces receipt of the signaling message to the adaptation functional unit, and

11. The method according to claim 9,
wherein the connection-oriented signalling is based on a SCTP/IUA protocol, and
wherein the message-oriented signalling is based on a MGCP or H.248 protocol.

12. The method according to claim 11,
wherein the packet control unit comprises:
a maintenance functional unit, and
an adaptation functional unit,
wherein the signalling message is transmitted to the maintenance functional unit by the message-oriented signalling,
wherein the maintenance functional unit announces receipt of the signaling message to the adaptation functional unit, and
wherein the adaptation functional unit establishes a signalling connection to the redundant connection unit by the connection-oriented signaling in response to the announcement.

13. A method for transmitting signalling information via a network limiting element, which connects a packet-switched communications network and a circuit-switched communications network, comprising:
providing the network limiting element having a plurality of gateway interfaces for connecting to the packet-switched communications network via a message-oriented control channel and a connection-oriented control channel, wherein at least one of the plurality of interfaces includes an active connection unit and a redundant connection unit;
generating, by the network limiting element, a signalling message indicating a changeover; and
sending the signaling message over the message-oriented control channel to the packet switched network; and
establishing a signaling connection to the redundant connection unit in response to the signaling message over the message-oriented control channel,
wherein the redundant connection unit becomes the active connection unit in response to the changeover.

14. The method according to claim 11,
wherein the packet-switching network includes a packet control unit comprising:
a maintenance functional unit, and
an adaptation functional unit,
wherein the signalling message is transmitted to the maintenance functional unit by the message-oriented signalling,
wherein the maintenance functional unit announces receipt of the signaling message to the adaptation functional unit, and
wherein the adaptation functional unit establishes a signalling connection to the redundant connection unit by the connection-oriented signaling in response to the announcement.
